(19) United States
(12) Patent Application Publication
(10) Pub. No.: US 2026/0296860 A1
(43) Pub. Date: Oct. 1, 2026

(54) STABILISING DEVICE

(71) Applicant: SYSTEM CERAMICS S.P.A., FIORANO MODENESE (MODENA) (IT)

(72) Inventor: ENRICO MERIGHI, FIORANO MODENESE (IT)

(21) Appl. No.: 19/478,425

(22) PCT Filed: May 6, 2024
(86) PCT No.: PCT/IB2024/054380

§ 371 Date: Oct. 24, 2025

(30) Foreign Application Priority Data
May 9, 2023 (IT) 102023000009225

(51) Int. Cl. B66F 9/18; B66F 9/06; B66F 9/075

(52) U.S. Cl. CPC B66F 9/18; B66F 9/063; B66F 9/0755

(57) ABSTRACT

A device for stabilising an object supported on a support plane and having an upper surface, comprising a main frame movable along at least one vertical direction between a rest position, elevated with respect to the object, and a stabilising position in which the main frame is supported on the upper surface of the object, wherein the main frame includes at least one contact element, which is movable with respect to the main frame at least in a vertical direction between a constraint position and a raised position; in the constraint position the contact element protrudes at least partially from the lower part of the main frame; in the raised position, the contact elements do not protrude, or protrude from a lower portion relative to the constraint position, from the main frame. Operating vehicle comprising the stabilising device.

The present invention relates to a loading stabiliser for an operating vehicle.

In particular, the invention relates to a loading stabiliser for an operating vehicle provided with a lifting fork, arranged to be inserted below an object to be transported, and to lift and lower the object as a function of the loading/unloading and transport operations to be carried out.

The invention finds particularly advantageous use in self-driving loading vehicles, for example AGV or LGV.

Operating vehicles are used for lifting loads, for example packages located in storage warehouses or leaving a packaging unit, at the end of a production line.

Operating vehicles, in particular self-driving operating vehicles, comprise a self-propelled unit, responsible for movement of the operating vehicle along a direction of displacement, to which an operating part is connected, responsible for the action of lifting the packages.

The operating part, in fact, is associated with a fork, movable in a vertical direction, which may be manoeuvred in different ways, depending on the type of vehicle and the type of control: the fork is arranged to load a package and to be moved in a vertical direction.

Self-driving operating vehicles, equipped with a loading and fork lifting system, are known in the art.

Furthermore, these vehicles known in the art comprise a stabilising element, flat in shape, belonging to the operating part and positioned above the package: the stabilising element may be translated by means of movement means from a higher level in the rest position to a lower level in the active position, the latter supported on an upper surface of the package.

The advantage achieved by the use of a stabilising element is that, thanks to a force exerted by it on the package, it is able to guarantee a more stable transport of the package on the forks of the operating vehicle.

An example of an operating vehicle comprising a lifting fork and a stabilising element is illustrated in patent application number IT202200014716 in the name of the same applicant.

The stabilising element introduced above acts in a vertical direction.

The force exerted by the stabilising element grants a better stability and safety of transport, with respect to an operating vehicle comprising only the fork: in fact, thanks to the force exerted, it is possible to counteract a large part of the stresses that occur during the vehicle displacement phase and that risk causing the package being transported to fall.

On the other hand, however, particularly in the case of lifting of a plurality of overlapped packages or boxes, it is necessary to provide a further constraint with respect to the transverse stresses, in order to stabilise the plurality of packages with respect to the vertically directed displacements.

To cope with this type of transverse stresses, in the prior art the plurality of overlapped packages or boxes, before being loaded and transported, are subjected to packaging operations, capable of providing a constraint element to counteract the transverse stresses, as well.

One of the methods used in the prior art is the use of straps: a strapping machine identifies an application plane of at least one strap and is arranged to cause the loop winding of at least one strap around a plurality of overlapped packages; the loop applied is coplanar with respect to the plane identified by the strapping machine. The main function of each strap is to prevent unwanted reciprocal slipping between overlapped packages.

The need to apply one or more straps to the package, however, introduces a further step into the production process, in particular a further step into the packaging process, requiring additional time.

Furthermore, strapping machines cause consumption in terms of energy to perform the strap application operations.

Finally, strapping machines may apply even a considerably high number of straps to be able to guarantee a sufficiently secure packaging of a plurality of overlapped packages, in order to be transported on an operating vehicle. Therefore, packaging by means of a strapping machine requires a large quantity of straps and, therefore, of raw materials.

Other types of packaging known in the art may be used, but, in most cases, causing a not insignificant consumption in terms of time, energy and materials.

Similar considerations can be applied to a plurality of packages that are positioned side by side, rather than being overlapped: in this case as well, it is necessary to provide a further stabilising constraint, in addition to the stabilising element mentioned above, in order to create a safer transport of the plurality of packages positioned side by side in a horizontal direction: in this case as well, the limit is overcome in the prior art through the application of straps by means of a strapping machine.

In this case, however, the strapping machine should have an application plane of the straps that is different to the previous one, since the stacking direction of the packages to be transported is different, namely horizontal and not vertical.

A further limit, therefore, is that each type of side-by-side positioning of sheets requires a strapping machine having a specific application plane.

Therefore, the system of packaging by means of straps for the transport of packages on operating vehicles is improvable, not only in terms of consumption of resources, but also in terms of versatility.

Furthermore, even in the presence of a package packaged with straps, transport on an operating vehicle comprising a stabilising element of the type described in patent application number IT202200014716 might not be sufficient: in the case of non-rectilinear trajectories, in the presence of obstacles or a not perfectly even support plane, the stresses could equally cause slipping and falling of the package loaded on the fork.

The operating vehicles known to the system are improvable not only in the case of transport of a plurality of packages overlapped in a vertical direction or positioned side by side in a horizontal direction, with or without straps, but also in the case of transport of individual packages, for example, of individual packages of large dimensions or with unusual geometries: these individual packages cannot be easily stabilised solely by the stabilising element indicated above.

Furthermore, a vehicle comprising a stabiliser of the type described above has a constraint from a dimensional viewpoint: a stabiliser, since it has a flat surface of specific dimensions, stabilises well packages having an upper surface and lower surface similar to the flat surface of the stabiliser; vice versa, these dimensions might not be sufficient to stabilise packages having an upper surface and lower surface of bigger or smaller dimensions with respect to the surface of the stabilising element.

The object of the present invention is to provide a device capable of overcoming the limits of the prior art, improving the stability of transport of packages by means of operating vehicles.

Additional features and advantages of the present invention will become more apparent from the following detailed description of an embodiment of the invention in question, illustrated by way of non-limiting example in the appended figures, in which:

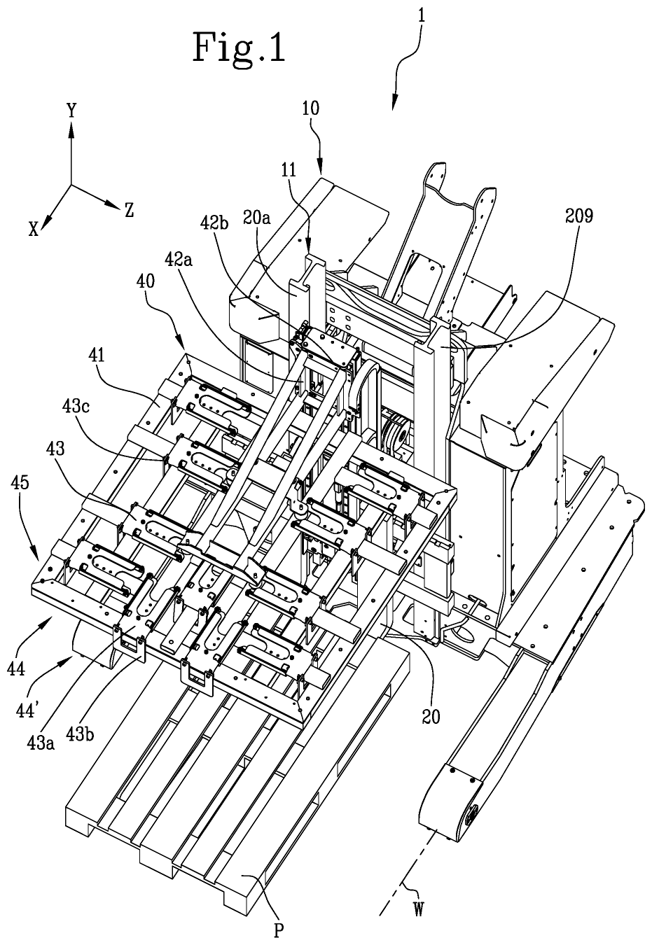

FIG. 1 shows an isometric view from above of a stabilising device in a rest position;

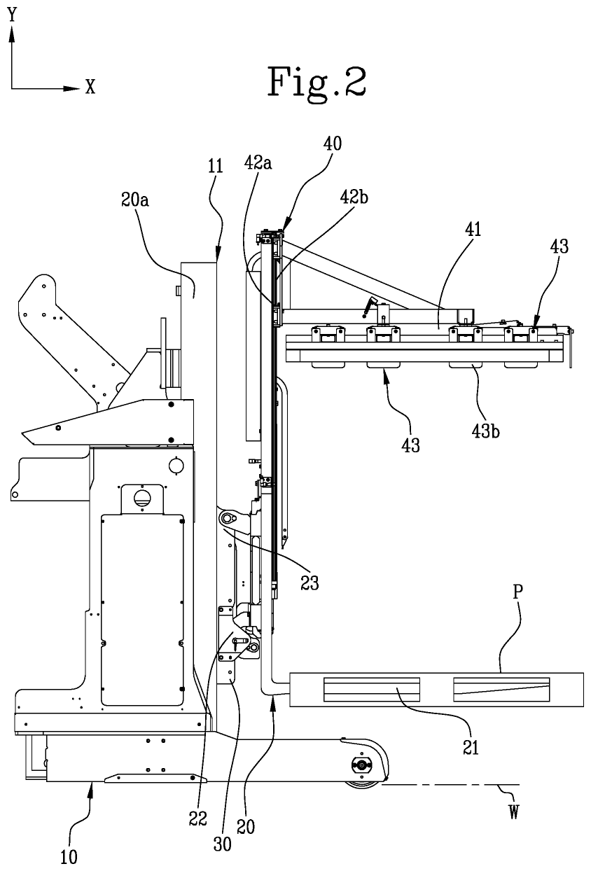

FIG. 2 shows a lateral view of the stabilising device of FIG. 1.

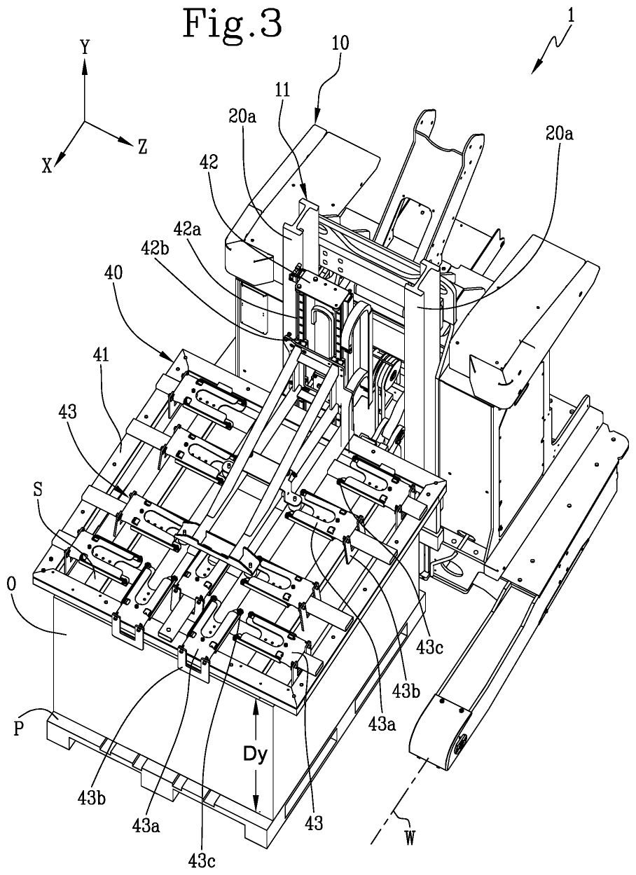

FIG. 3 shows an isometric view from above of the stabilising device of FIG. 1, in the position of stabilising of an object.

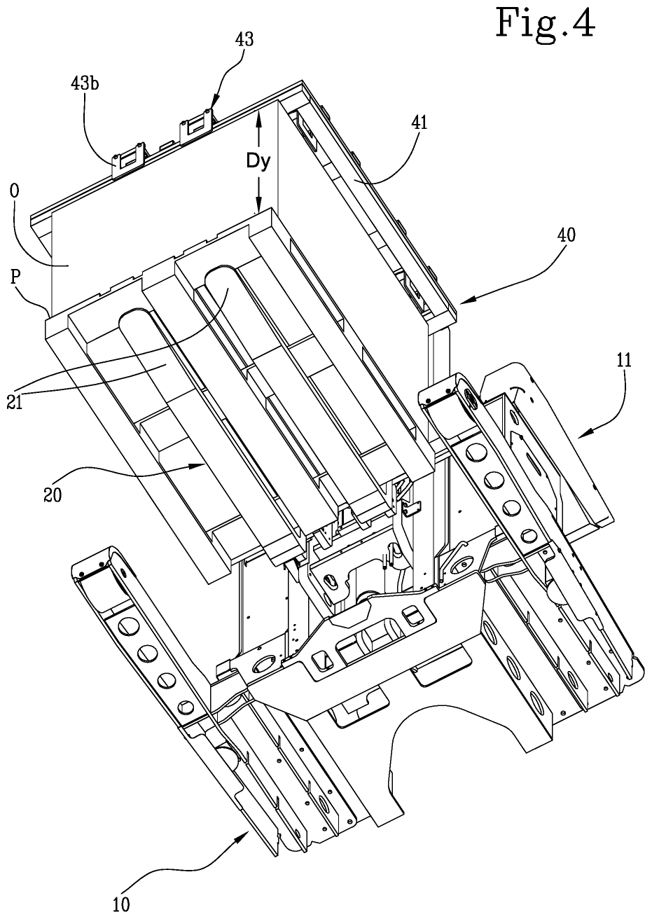

FIG. 4 shows an isometric view from below of the stabilising device of FIG. 3.

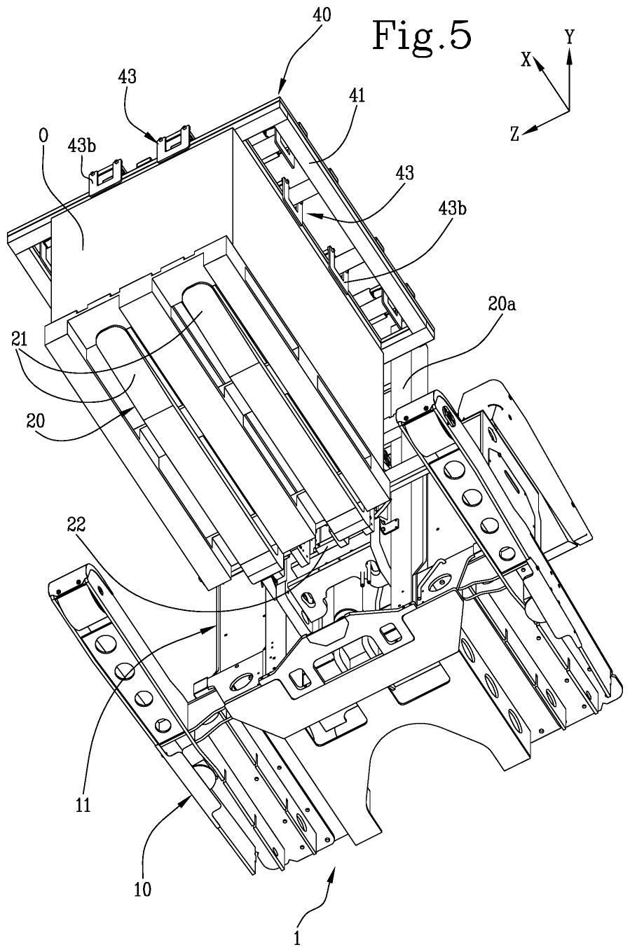

FIG. 5 shows an isometric view from below of the stabilising device of FIG. 1 in the position of stabilising of an object O of smaller dimensions with respect to FIGS. 3 and 4.

In detail, the main object of the present invention is to provide a stabilising device capable of determining a more secure and stable transport of individual packages, overlapped or positioned side by side, without having necessarily to resort beforehand to complex packaging operations.

The stabilising device according to the present invention is particularly useful on board an operating vehicle (1) arranged for the transport and the lifting/lowering of objects.

The operating vehicle (1) comprises a self-propelled unit (10), arranged to displace on a displacement plane (W), along a main direction (X), following a given path.

The self-propelled unit (10) is the part of the operating vehicle (1) responsible for displacement.

The self-propelled unit (10) is of the type known in the art and comprises a motor, a plurality of wheels and a steering system, arranged to allow the self-propelled unit (10) to follow straight and curved trajectories.

The operating vehicle (1) comprises, furthermore, an operating part (11), associated with the self-propelled unit (10). The operating part (11) is the component responsible for the operation of loading and lifting of an object (O).

Object (O) means, preferably, a plurality of packages positioned side by side in a horizontal direction or stacked in a vertical direction; object (O) means, alternatively, a single package comprising a lower surface, an upper surface and a plurality of lateral sides. Object (O) means, also, a package having different geometric characteristics.

The operating part (11) comprises a fork (20), arranged to load the object (O) on board, allowing, therefore, lifting by the operating part (11).

The fork (20) is vertically movable between a lower position and an upper position.

In the lower position, the fork (20) can be inserted below an object (O) to be loaded on board. Typically, in the lower position, the fork (20) is close to the ground; the distance from the ground is suitable to allow insertion below the object (O) to be loaded on board. For example, the height of the fork (20) from the ground in the lower position is suitable to allow insertion below a standardised pallet.

The upper position of the fork (20) is located at a certain height from the ground: said level depends on a plurality of factors, including the dimensions and overall weight of the operating vehicle (1), the dimensions and weight of the object (O) to be loaded and the maximum level at which the objects are envisaged to be unloaded or picked up.

The fork (20) may be arranged at any intermediate position between the lower position and the upper position.

The self-propelled unit (10) also comprises a frame arranged to support the components cited above and others that will be described below.

Other elements, not further specified or described, are known to the person skilled in the art and, therefore, attributable to the prior art.

In the preferred, but not exclusive, embodiment, the fork (20) comprises a pair of arms (21). The arms (21) are parallel to each other, substantially horizontal and protruding from the operating part (11), i.e. protruding from the operating vehicle (1). Furthermore, the arms (21) define a support plane (P) for the object (O). Said support plane (P) for the object (O) is normally parallel to the displacement plane (W) of the operating vehicle (1):

The arms (21) are arranged to be inserted below the object (O) to be loaded.

In a preferred embodiment, the fork (20) is associated with a support (22). Preferably, the fork (20) is associated with the support (22) with the possibility of translation along a transverse direction (Z). The transverse direction (Z) is perpendicular to the main direction (X).

In detail, the arms (21) of the fork (20) are associated with first movement means arranged to make the arms (21) slide along the support (22) in the transverse direction (Z); preferably, the arms (21) move towards or away from each other. This reciprocal movement of the arms (21) advantageously allows the configuration of the fork (20) to be adapted to the dimensions of the object (O) to be loaded.

The fork (20) is also associated with guides (20a), preferably arranged in a vertical direction (Y). In other words, the fork (20) is associated with a further support (23) and with second movement means; the second movement means is arranged to make the support (23) and, therefore, the fork (20), slide in the vertical direction (Y).

The second movement means allow the fork (20) to be moved from a loading position of the object (O) to an elevated position, corresponding, for example, with an unloading position of the object (O), and vice versa.

Preferably, the operating vehicle (1) comprises a detection sensor (30) provided with a detecting field (R), turned towards the fork (20) and, in detail, towards the space occupied by the fork (20); the space occupied by the fork comprises the fork (20) and the object (O) loaded onto it.

The sensor (R) is arranged to detect the presence of obstacles, such as objects or people, which may be in front of the operating vehicle (1); in other words, if obstacles are present along the trajectory followed by the operating vehicle (1) and in the detecting field (R), the detection sensor is arranged to emit a detecting signal.

Preferably the detection sensor (30) is movable in the vertical direction (Y) between a lower position and an upper position. The lower position is at a height from the support surface of the operating vehicle (1) that is lower with respect to the upper position.

Both when it is positioned at the lower level, when it is positioned at the upper level, and for the entire duration of displacement in the vertical direction, the detection sensor (30) turns its detecting field (R) towards the space occupied by the fork (20).

In other words, a translation of the detection sensor (30) in a vertical direction (Y) corresponds to the movement in a vertical direction (Y) of the fork (20) along the guides (20a), so that the detecting field (R) always covers the space occupied by the fork (20); in this manner, it is possible to detect the presence of obstacles that affect the main direction (X) of the operating vehicle (1), whatever the level at which the fork (20) is positioned.

The detection sensor (30) may be associated with the fork (20): in this configuration, the detection sensor (30) moves solidly constrained with it and exploits its movement system.

In another embodiment, the detection sensor (30) is associated with its own system of guides and movement means, different to and independent from the guides and movement means of the fork (20). In this embodiment, the movement means are commanded by a specific control module.

The detection sensor (30) is preferably located in a substantially median position with respect to the arms (21) of the fork (20).

The detection sensor, lastly, is of the type known in the art; for example, the detection sensor is of the PLS type.

The detecting signal emitted by the detection sensor (30) is sent to a control module; the control module is arranged to detect the signal emitted by the detection sensor (30) and to command a safety manoeuvre of the self-propelled unit (10). For example, in the presence of an obstacle detected by the detection sensor (30), the control module is arranged to stop the vehicle's motor and/or to brake the vehicle itself and/or to stop the fork (20), using command algorithms known in the art.

An example of an operating vehicle comprising a detection sensor (30) provided with the aforementioned features is described in patent application number IT202200014716, in the name of the same applicant.

The operating vehicle (1) further comprises a stabiliser (40).

In a preferred, but not exclusive, embodiment, the stabiliser (40) according to the present invention comprises a main frame (41). The main frame (41) defines an operating plane, turned towards the fork (20), which is oriented in a manner substantially parallel to the support plane (P) for the object (O), defined by the arms (21) of the fork (20). Normally, the operating plane of the main frame (41) is substantially parallel to the displacement plane (W) of the operating vehicle (1).

Furthermore, for simplicity of depiction and understanding, the displacement plane (W) is shown as parallel to the horizontal plane; however, the displacement plane (W) may have a different inclination, provided that it is compatible with the functioning of the operating vehicle (1).

As will be explained better below, the operating plane of the main frame (41) is intended to come into contact with an object (O) arranged on the fork (20).

The main frame (41) belonging to the stabiliser (40) is positioned above the fork (20) and is spaced away from the fork (20) by a variable level.

The main frame (41) is movable in a vertical direction (Y), in approach towards and away from the fork (20). The main frame (41) is, in fact, connected to movement means, known in the art, arranged to implement its displacement in the vertical direction (Y).

The function performed by the stabiliser (40), through the main frame (41), is that of being positioned supported on the upper surface of the object (O) loaded on the fork (20).

In other words, the stabiliser (40), by means of movement means, causes displacement of the main frame (41) from a rest position (RP) to a stabilising position (SP).

According to the preferred embodiment, the rest position (RP) is situated at a higher level with respect to the stabilising position (SP), i.e. at a greater height, with respect to the support plane (P) of the vehicle.

The stabilising position (SP) is variable and depends substantially on the dimension (Dy) in a vertical direction (Y) of the object (O). In other words, the level of the stabilising position (SP) with respect to the support plane defined by the arms (22) depends on the dimension (Dy) in a vertical direction of the object (O).

The displacement in the vertical direction (Y) of the main frame (41) is performed by motor means along a support structure (42): the support structure (42) comprises one or more vertical guides. In the preferred embodiment illustrated in FIGS. 1 to 5, the support structure (42) comprises a vertical guide (42a), along which a carriage (42b) is slidable. The carriage (42b) is connected to the main frame (41).

The activity of stabilising the object (O) on the fork (20) by the stabiliser (40) is managed and adjusted by the control system: the control system, once the object (O) is positioned on the fork (20), sends an operating command to the motor means. In this manner, the main frame (41), which was previously in the rest position (RP), is moved in the vertical direction (Y), downwards; the travel of the main frame (41) along the vertical guide (42a) continues until the main frame (41) enters into contact with the upper surface of the object (O) at the operating plane. The level reached by the main frame (41), when it is in contact with the upper surface of the object (O), represents the stabilising position (SP).

In detail, the functioning of the stabiliser (40) according to the present invention is described below.

The operating vehicle (1), through the action of the self-propelled unit (10) and the control system, travels along a trajectory of approach to the object (O) to be loaded and transported.

When a loading position of the object (O) has been reached, the operating vehicle (1) comes even closer to the object (O), inserting the fork (20) below the object (O). Before said insertion, the fork (20) moves into a lower position and the stabiliser (40) moves into the rest position (RP), in the case that these positions have not already been reached previously.

Subsequently, the object (O) is loaded onto the fork (20).

The control system generates an operating command of sliding to the motor means connected to the stabiliser (40): in detail, the motor means cause sliding of the carriage (42b) in a vertical direction (Y) along the guides (42a). In this manner, the main frame (41) connected to the carriage (42b) slides downwards from the rest position (RP) until it enters into contact with the upper surface of the object (O); the travel of the main frame (41) stops supported on the upper surface of the object (O), in the stabilising position (SP).

When the main frame is in the stabilising position (SP), it exerts a direct force downwards on the object (O), providing a first stabilising element, as previously illustrated.

A further stabilising level, advantageously provided by the object of the present invention, is described in the following paragraphs.

The stabiliser (40) according to the present invention comprises one or more contact elements (43), arranged to prevent displacement of the object (O) on a horizontal plane, mainly in the transverse direction (Z) and in the main direction (X). In other words, the contact elements (43) constitute a constraint on movement of the object (O) in the transverse direction (Z) and in the main direction (X), when the object (O) is loaded on the fork (20).

Therefore, the addition of at least one contact element (43) to the stabilising device (40) allows, in a very advantageous way, defining an abutment element for the object (O) in relation to the movements on the horizontal plane: therefore, the object (O) loaded on the fork (20) can be transported along a predefined path, without the transport being interrupted or influenced by the stresses on the horizontal plane, which would cause the object (O) to fall in the absence of the contact elements (43) The contact elements (43) according to the present invention will be described in detail in the following paragraphs.

Each contact element (43) is movable and, in particular, each contact element (43) has at least one movement component in a vertical direction (Y). In other words, each contact element (43) is movable at least in a perpendicular direction with respect to the operating plane of the main frame (41).

The movement of each contact element (43) occurs between a constraint position (BP) and a raised position (HP). In the constraint position (BP), each contact element (43) protrudes from the lower part of the main frame (41), i.e. it protrudes from the operating plane of the main frame (41), according to the vertical direction (Y); in other words, each contact element (43) in the constraint position (BP) is protruding from the main frame (41), in direction (Y), towards the support plane (P) identified by the fork (20).

In the constraint position (BP) the contact element (43) is arranged to constrain the displacements of the object (O) in the transverse (Z) and main (X) directions; in other words, in the constraint position (BP) the contact element (43) advantageously prevents the object (O) from moving on the horizontal frame.

In the raised position (HP), on the other hand, the contact element (43) does not protrude from the main frame (41), or protrudes by a smaller portion with respect to the constraint position (BP); in the raised position (HP), the contact element (43) does not interfere substantially with the displacements of the object (O) directed on the horizontal plane, particularly along the main (X) and transverse (Z) directions.

As described, the contact element (43) is movable between the constraint position (BP) and the raised position (HP) defined above; in detail, the constraint element (43) is free to displace itself from the constraint position (BP) to the raised position (HP) as a result of a thrust having a component directed upwards. In particular, the contact element (43), which is positioned at least partially within the outline of the upper surface of the object (O), is pushed from the constraint position (BP) towards the raised position (HP) as a result of a contact with the object (O) during descent of the flat frame (41).

In other words, the contact elements (43) that are positioned at least partially within the outline of the upper surface of the object (O) stop their own descent in contact with the object (O), moving from the constraint position (BP) to the raised position (HP).

Essentially, thanks to the possibility of displacing itself freely from the constraint position (BP) to the raised position (HP) as a result of a thrust having at least one component in the vertical direction (Y) and upwards, the contact elements (43) are capable of raising themselves towards the raised position (HP) in the case in which, during a travel downwards of the main frame (41), they enter into contact with the object (O). As will be better illustrated in the following paragraphs, this allows a certain number of contact elements (43) to be arranged distributed in positions such as to adapt the action exerted by each contact element (43) to the actual dimensions of the object (O).

In fact, when the main frame is in the stabilising position (SP) on the object (O), among the contact elements (43), only those situated outside the outline of the upper surface of the object (O) maintain the constraint position (BP): these contact elements (43) are arranged to function as an abutment element, to prevent movements on the horizontal plane.

In an alternative embodiment, the contact elements (43) are constrained to the main frame (41) and are oscillating with respect to the main frame (41) between the constraint position (BP) and the raised position (HP). In this case, in detail, when the main frame (41) is in the stabilising position (SP), i.e. supported on the upper surface of the object (O), the contact elements (43) that are initially in the constraint position (43) and that are positioned inside the outline of the upper surface of the object (O) move freely oscillating, until they reach the raised position (HP). In other words, the contact elements (43) are subjected to an oscillation caused by the thrust having at least one component in a vertical direction, upwards: said oscillation allows passage from the constraint position (BP) to the raised position (HP) of the contact elements (43) situated inside the outline identified by the upper surface of the object (O).

The contact elements (43) situated outside said outline, on the other hand, maintain the constraint position (BP), performing the function of abutment for the object (O), preventing movements on the horizontal plane, in particular in the main (X) and transverse (Z) directions.

In a first embodiment, the contact elements (43) have a substantially prismatic or cylindrical shape, but further geometries are not excluded, preferably, but not exclusively, with longitudinal development. Therefore, the contact elements (43) according to the first embodiment have a circular, rectangular, square or other type of section.

In a further embodiment, the contact elements (43) are rotatably constrained to the main frame (41); in particular, the contact elements (43) comprise at least a first portion constrained by means of a hinge to the main frame (41); the contact elements (43) further comprise a second portion arranged to rotate freely around the axis identified by the hinge, between the constraint position (BP), in which they protrude below with respect to the operating plane identified by the main frame (41), and the raised position (HP), in which they do not protrude below or protrude below with respect to the operating plane by a smaller portion with respect to the constraint portion (BP).

In detail, considering an object (O) positioned on the support plane (P), the contact elements (43) positioned inside the outline delimiting the upper surface of the object (O) are subjected to a thrust force having at least one component in the vertical direction (Y) and upwards, and are free to rotate from the constraint position (BP) to the raised position (HP) as a result of said thrust. Vice versa, the contact elements (43) situated outside said outline maintain the constraint position (BP), performing the function of abutment and preventing movements on the horizontal plane, in particular in the main (X) and transverse (Z) directions.

From a structural viewpoint, the contact elements (43) may have, in a first embodiment, a configuration defined by at least one component extending in a vertical direction (Y); in other words, the contact elements (43) have at least one component extending in a perpendicular direction to the operating plane identified by the main frame (41).

The contact elements (43) according to this first embodiment are free to slide, oscillate or rotate as described in the previous paragraphs; the contact elements (43) according to this first embodiment can also perform combinations of the movements previously described.

In a preferred, but not exclusive, embodiment, illustrated in detail in FIGS. 1 to 5, the contact elements (43) are rotatably constrained to the main frame (41) by means of hinges (43c).

Preferably, the contact elements (43) comprise a first portion (43a), rotatably constrained to the main frame (41) by means of a hinge (43c), and a second portion (43b), connected to the first portion (43a) and inclined with respect to it.

Preferably, but not exclusively, the inclination between first portion (43a) and second portion (43b) is substantially 90°, giving the support element an L shape; however, different inclinations are not excluded, provided that they are compatible with the abutment function of the contact elements (43).

In the aforesaid preferred embodiment, in other words, the contact elements (43) have a first and second portion (43a,43b) substantially perpendicular to each other; the hinge (43c) constrains the free end of the first portion (43a) of the contact element (43), allowing rotation of the contact element around the axis identified by the hinge (43c).

In detail, the contact element (43) in the constraint position (BP) has the first portion (43a) supported on the main frame (41) and the second portion (43b) protruding below with respect to the operating plane (41) identified by the flat frame (41); in the raised position (HP), on the other hand, the contact element (43) is rotated upwards, as a result of the rotating constraint provided by the hinge (43c): in other words, the first portion (43a), rotating around the axis identified by the hinge (C) is raised with respect to the main frame (41) and therefore no longer in contact with the flat frame (41); at the same time, the second portion (43b) does not protrude below or protrudes below with respect to the operating plane by a smaller portion with respect to the constraint position (BP).

The rotation around the axis identified by the hinge (43c) depends on the thrust force in a vertical direction (Y) and upwards exerted by the object (O) supported on the fork (20) on the flat frame (41) in the stabilising position (SP) and on the respective contact elements (43). In detail, the contact elements situated inside the outline delimiting the upper surface of the object (O) are subjected to the aforesaid thrust action and, consequently, rotate upwards, around the axis identified by the respective hinge (43c), passing from constraint position (BP) to raised position (HP); vice versa, the contact elements (43) positioned outside the outline delimiting the upper surface of the object (O) maintain the constraint position (BP), preventing movements of the object (O) on the horizontal plane.

In the preferred embodiment, the stabiliser (40) comprises a plurality of contact elements (43) of the L-shaped type described in the previous paragraphs.

In the preferred embodiment of the stabilising element (40), in constraint position (BP), each contact element (43) is constrained medially with respect to the main frame (41) by means of the hinge (43c), with the first portion (43a) supported on the main frame (41) and the second portion (42b) protruding vertically downwards, i.e. below the operating plane of the main frame (41).

With respect to the hinge (43c), the second portion (43b) is positioned moving away from the medial portion of the main frame (41); in other words, the second portion (43b) is closer to the margins of the main frame (41) with respect to its own first portion (43a).

Preferably, but not exclusively, the constraint elements (43) are positioned side by side in one or more rows (44,44′) parallel to the main direction (X); the contact elements (43) positioned side by side in rows (44,44′) constrain mainly, but not exclusively, movements in the transverse direction (Z).

Preferably, the stabiliser (40) comprises at least one further row (45) of contact elements (43), arranged parallel to the transverse axis (Z); the contact elements (43) positioned side by side to form the row (45) constrain mainly, but not exclusively, movements in the main direction (X). The contact elements (43) are movable independently from each other.

When an object (O) is loaded on the fork (20), the control system sends an operating command to the motor means, which cause movement of the main frame (41) of the stabiliser (40) from the rest position (RP) to the stabilising position (SP), supported on the upper surface of the object (O).

During displacement of the main frame (41) from rest position (RP) to stabilising position (SP), the contact elements (43) are in the respective constraint position (BP), with the first portion (43a) supported on the main frame (41) and the second portion (43b) protruding below from the operating plane, in the direction of the fork (20).

When the main frame (41) positions itself in the stabilising position (SP), in contact with the upper surface of the object (O), the second portions (43b) of the contact elements (43) that are positioned inside the outline of the upper surface of the object (O) will undergo a thrust at least in the vertical direction (Y) and upwards, caused by the contact with the object (O), as described in the previous paragraphs; the aforesaid thrust causes rotation around the axis identified by the respective hinges (43c) and upwards of these contact elements (43), until they reach the raised position (HP). The contact elements (43) that, on the other hand, have the second portion (43c) outside the outline of the upper surface of the object (O) remain in constraint position (BP), preventing movement of the object (O) on the horizontal plane.

A further aspect of the present invention relates to the support structure (42) of the main frame (41).

According to the present invention, the support structure (42) is arranged to allow the main frame (41) to be moved in the vertical direction (Y); furthermore, the support structure (42) is arranged to allow the main frame (41) to rotate around the main axis (X), within a certain tolerance range; lastly, the support structure (42) is arranged to allow the main frame (41) also to rotate around the lateral axis (Z), within a certain tolerance range.

When the operating part (11) loads an object (O) characterised by a particularly high weight, the fork (20) could be subject to a bending downwards of its most distal portion: in this manner, the support plane (P) identifies an angle (α) of rotation with respect to the horizontal plane: the angle (α) comprised between the extension direction of the arms (21) of the fork (20) and the parallel to the horizontal plane, in the case of a particularly heavy object (O), is different from zero.

The main frame (41) is arranged to be able to rotate by the same angle (α) around the transverse axis (Z): advantageously, in this manner, the constraint effect is guaranteed and, hence, the effect of retaining the object (O) even in non-perfect conditions of alignment with the displacement plane (W) of the operating vehicle (1).

Furthermore, certain objects (O) may have an upper surface not perfectly parallel with respect to the support plane (P): to guarantee the stabilising effect even in the case of an object (O) of this type, the main frame (41) may also rotate around the main axis (X). In this manner, the main frame (41) assumes a better and more adherent rest position, guaranteeing the stabilising effect described above.

Once stabilised, the object (O) can be raised and/or transported safely to its final destination.

Advantageously, the contact elements (43) described above, jointly with the force in the vertical direction exerted by the main frame (41), prevent the object (O) from moving or sliding in the transverse direction (Z), in the main direction (X) or in other directions belonging to the horizontal plane, when the object (O) is transported by the operating vehicle (1), counteracting oscillations and stresses to which the operating vehicle (1) may be subject when travelling along a specific trajectory.

Advantageously, the stabiliser (40) according to the present invention allows secure and stable transport of objects (O) of various dimensions and the most appropriate contact elements (43) according to the dimensions and geometry of the object (O).

Advantageously, when the object (O) comprises a plurality of packages overlapped in a vertical direction (Y), the plurality of contact elements (43) counteract the sliding of each package with respect to the others.

Advantageously, furthermore, the plurality of contact elements (43) counteract said sliding of each package on the others even in the absence of packaging elements, such as straps or other devices of this type.

Advantageously, when the object (O) comprises a plurality of packages positioned side by side in a transverse direction (Z) or a main direction (X), the plurality of contact elements (43) counteract unwanted falls of the packages during the transport phase.

Advantageously, furthermore, the plurality of contact elements (43) counteract said falls even in the absence of packaging elements, such as straps or other devices of this type.

Lastly, a further advantage of the stabiliser (40) according to the present invention is that the plurality of contact elements (43) is capable of stabilising a plurality of packages positioned side by side or overlapped and packaged with straps or other packaging devices, without having to consider how the straps previously applied are oriented in space. In other words, for example, given a plurality of packages overlapped to form the object (O), if the straps are tightened in a loop along the plane (XY), the contact elements (43) provide a further constraint to sliding in the transverse direction (Z).

In a further advantageous manner, therefore, the plurality of contact elements (43) allows the number of straps applied to be reduced, and, therefore, the energy and materials consumed.

1. A device for stabilising an object supported on a support plane and having an upper surface, comprising a main frame movable along at least one vertical direction between a rest position, elevated with respect to the object and a stabilising position in which the main frame is supported on the upper surface of the object;
wherein the main frame comprises at least one contact element, which is movable with respect to the main frame at least in a vertical direction between a constraint position and a raised position; in the constraint position the contact element protrudes at least partially from the lower part of the main frame; in the raised position, the contact elements do not protrude, or protrude from a lower portion relative to the constraint position, from the main frame.

2. The stabilising device according to claim 1, wherein the contact element:
in the constraint position defines an abutment to the object for the movements in the horizontal plane;
in the raised position does not define an abutment to the object for the movements in the horizontal plane.

3. The stabilising device according to claim 1, wherein the contact element is constrained to the main frame and oscillates between the constraint position and the raised position.

4. The stabilising device according to claim 1, wherein the contact element comprises:
a first portion and a second portion, the first and second portion being inclined with each other;
a hinge situated at the first portion and arranged to rotatably constrain the contact element to the main frame.

5. The stabilising device according to claim 4, wherein the contact element is movable between the constraint position, supported on the main frame, and the raised position, in which the contact element is rotated away from the main frame and upwards.

6. The stabilising device according to one claim 1, wherein the contact elements are arranged along at least one row, parallel to the transverse axis.

7. The stabilising device according to claim 1, wherein the contact elements are arranged along at least two rows parallel to the main axis.

8. The stabilising device according to claim 1, wherein the main frame is connected to a support structure comprising: a vertical guide arranged substantially perpendicular to the main frame and a carriage constrained to the flat main frame and slidable along the vertical guide.

9. The stabilising device according to claim 8, comprising motor means arranged to move the carriage connected to the main frame along the vertical guide.

10. The stabilising device according to claim 1, wherein the main frame is arranged to rotate about the main axis and/or about the transverse axis and/or about the vertical axis.

11. An operating vehicle, comprising:
a self-propelled unit, structured to displace along a path, advancing on a rest displacement plane along a main direction;
a fork, associated with an operating part of the self-propelled unit and movable vertically between a lower position and an upper position, arranged to load an object having an upper surface;
a detection sensor, provided with a detecting field and arranged to emit a detecting signal if an object is inside the detecting field, said detecting field facing the space occupied by the fork;
wherein it comprises a stabilising device according to claim 1, associated with the operating part and arranged with the main frame above the fork, wherein the support plane is defined by the fork.

12. The operating vehicle according claim 1, wherein the stabiliser comprises a control system arranged for:
detecting the presence of the object on the fork;
sending the motor means a command to move the carriage connected to the main frame along the vertical guide, from the rest position to the stabilising position before starting the displacement along the path;
sending the motor means the operative command to maintain the aforesaid stabilising position for the duration of the displacement along the path;
sending the motor means an operative command to move the carriage connected to the main frame from the stabilising position to the rest position at the end of the displacement along the path.
